(19) United States
(12) Patent Application Publication
(10) Pub. No.: US 2022/0204028 A1
(43) Pub. Date: Jun. 30, 2022

(54) AUTONOMOUS DRIVING DUAL MODE CONTROL

(71) Applicant: HERE Global B.V., Eindhoven (NL)

(72) Inventors: Jingwei Xu, Buffalo Grove, IL (US); Yuxin Guan, Chicago, IL (US)

(21) Appl. No.: 17/565,164

(22) Filed: Dec. 29, 2021

Related U.S. Application Data
(60) Provisional application No. 63/132,094, filed on Dec. 30, 2020.

(51) Int. Cl. B60W 60/00; G05D 1/00; B60W 50/00

(52) U.S. Cl. CPC B60W 60/005; G05D 1/0011; B60W 50/00; B60W 2420/52; B60W 2556/45; B60W 2555/20; B60W 2420/42; B60W 2554/40

(57) ABSTRACT

Systems and methods include receiving probe data and sensor data from a mobile device, comparing conditions defined by the probe data and the sensor data to a requirement to enable a driver assistance feature for the mobile device, determining that the conditions fail to meet the requirement to enable the driver assistance feature based on the probe data and the sensor data, and outputting a navigation message to the mobile device providing for remote control of the mobile device when the conditions fail to meet the requirement to enable the driver assistance feature.

### CROSS-REFERENCE TO RELATED APPLICATIONS

This application claims priority to and incorporates by reference in its entirety, U.S. Provisional Patent Application No. 63/132,094, entitled “AUTONOMOUS DRIVING PATTERN PROFILE”, filed Dec. 30, 2020.

### FIELD

The following disclosure relates to determining a cause of a change in available driver assistance features.

### BACKGROUND

Mobile devices, including vehicles, may use different sensor technologies and high definition (HD) MAP or dynamic backend content, including traffic information services, to aid an in-vehicle control system for the right decision strategy as how to drive along the road network. For example, the control system may decide to enable or disable a driver assistance feature or capability based on the sensors and content.

However, the mobile device or vehicle may encounter conditions in the environment that do not support one or more driver assistance features. As a result, the driver assistance features may be disabled, sometimes called a “switchover.” In some cases, where the driver assistance features are disabled, the mobile device or vehicle may be operated by a remote operator.

### SUMMARY

In one embodiment, a method includes receiving probe data and sensor data from a mobile device, comparing conditions defined by the probe data and the sensor data to a requirement to enable a driver assistance feature for the mobile device, determining that the conditions fail to meet the requirement to enable the driver assistance feature based on the probe data and the sensor data, and outputting a navigation message to the mobile device providing for remote control of the mobile device when the conditions fail to meet the requirement to enable the driver assistance feature.

In one embodiment, a vehicle system includes an environment monitor configured to receive probe data and sensor data for a mobile device, a driver assistance manager configured to compare conditions defined by the probe data and the sensor data to a requirement to enable a driver assistance feature for the vehicle and to determine that the driver assistance feature is unsupported by the conditions based on the probe data and the sensor data, and a remote control coordinator configured to output a navigation message requesting remote control of the vehicle when the conditions fail to meet the requirement to enable the driver assistance feature.

In one embodiment, a non-transitory computer-readable medium including instructions that when executed are operable to, receive probe data and sensor data describing an environment of a vehicle, compare the environment described by the probe data and the sensor data to a pattern for disabling a driver assistance feature of the vehicle, determine that the environment matches the pattern for disabling a driver assistance feature of the vehicle, and output a navigation message to the vehicle providing for remote control of the vehicle when the environment matches the pattern for disabling the driver assistance feature.

### BRIEF DESCRIPTIONS OF THE DRAWINGS

Exemplary embodiments of the present invention are described herein with reference to the following drawings.

FIG. 1 illustrates a first example of a system for autonomous driving.

FIG. 2 illustrates an example driver assistance monitor of FIG. 1.

FIG. 3 illustrates a second example driver assistance monitor of FIG. 1.

FIG. 4 illustrates a system for remote control of a vehicle.

FIG. 5 illustrates an example of a message exchange.

FIG. 6 illustrates a second example of a message exchange.

FIG. 7 illustrates a third example of a message exchange.

FIG. 8 illustrates a fourth example of a message exchange.

FIG. 9 illustrates an example server for the system of FIG. 1.

FIG. 10 illustrates an example mobile device for the system of FIG. 1.

FIG. 11 illustrates an example flow chart for the server of FIG. 9 and the example mobile device of FIG. 10.

FIG. 12 illustrates an exemplary vehicle associated with the system of FIG. 1.

FIG. 13 illustrates an exemplary database.

### DETAILED DESCRIPTION

Driver assistance features aid drivers in driving and parking a vehicle. Such features may sometimes be referred to as “automated driving,” “highly automated driving,” “advanced driver assistance systems,” or “autonomous driving.” Driver assistance features may have different levels of sophistication, ranging from simple warning to complex systems that may drive a car without user input. The driver assistance features may be enabled by an engine control management (ECM) system on a vehicle. The driver assistance features may rely on different sensor technologies and high definition (HD) map or dynamic backend content, including traffic information services, to aid the in-vehicle ECM system for the right decision strategy as how to drive along the road network.

The society of automotive engineers (SAE) sorts driver assistance features into different levels, ranging from 0 to 5.

Level 0: An automated system may issue warnings and may momentarily intervene, but has no sustained vehicle control.

Level 1: The driver and the automated system share control of the vehicle. Examples of level 1 include adaptive cruise control (ACC), where the driver controls steering and the automated system controls speed, and parking assistance, where steering is automated while speed is manual. Level 1 may be referred to as “hands off” because the driver should be prepared to retake full control of the vehicle at any time. Lane keeping assistance (LKA) Type II is a further example of level 1 driver assistance.

Level 2: The automated system takes full control of the vehicle (accelerating, braking, and steering). The driver must monitor the driving and be prepared to intervene immediately at any time if the automated system fails to respond properly. Though level 2 driver assistance may be referred to as “hands off” because the automated system has full control of acceleration braking and steering, in some cases, contact between hand and steering wheel is often required to confirm that the driver is ready to intervene. In this way, the driver supervises the actions of the driver assistance features.

Level 3: The driver can safely turn their attention away from the driving tasks, e.g., the driver can text or watch a movie. Level 3 may be referred to as “eyes off.” The vehicle may handle situations that call for an immediate response, such as emergency braking. The driver should still be prepared to intervene within some limited period of time, often specified by the manufacturer, when called upon by the vehicle to do so. The car has a so-called “traffic jam pilot” that, when activated by a human driver, allows the car to take full control of all aspects of driving in slow-moving traffic at up to 60 kilometers per hour (37 miles per hour). However, the function works only on highways with a physical barrier separating one stream of traffic from oncoming traffic.

Level 4: Similar automated control as in level 3, but no driver attention is required for safety. For example, the driver may safely go to sleep or leave the driver's seat. Level 4 may be referred to as “mind off” or “driverless.” Self-driving in level 4 may be supported only in limited spatial areas (e.g., within geofenced areas) or under special circumstances, like traffic jams. Outside of these areas or circumstances, the vehicle may safely abort the trip (e.g., park the car or pull over) if the driver does not retake control.

Level 5: No human intervention is required to drive the vehicle. As a result, a vehicle with level 5 driver assistance features may not require or have a steering wheel installed. An example would be a robotic taxi. Level 5 driver assistance may be referred to as “autonomous driving” because the vehicle may drive on a road without human intervention. In many cases, it is used as the same term as a driverless car, or a robotic car.

Greater numbers of vehicles with driver assistance features may make roadways safer, given advanced environment sensing capabilities, development of machine learning models over different kind of sensor technologies (e.g., camera, radar, light detection and ranging (LIDAR)), vehicle to vehicle communications, and vehicle to infrastructure communication.

Driver assistance features may require certain minimum conditions to function. For example, driver assistance features may require a minimum level of wireless network performance, minimum functionality of one or more sensors, and/or alignment with a map or path. If one or more of the conditions are met, the driver assistance features may be disabled.

Driver assistance features may rely on map content to operate the vehicle. For example, a predetermined or dynamic path of a vehicle may be based on the map content. However, locations may lack map content, such as parking garages, underground areas, parking lots, back lots, or storage yards. Without map content, the driver assistance features may be unavailable.

For example, inclement weather such as rain, snow, fog, dust, or smoke may impair sensors. LIDAR sensors may not be able to gather accurate ranging data under such conditions. Additionally, extreme heat or cold may affect the sensors. Sensors may fail when exposed to temperatures outside of the operating range of the sensors. Further, map features, such as lane position, speed limit, and signage may contradict measurements from sensors.

Road geometry (such as a rough road from grading, pot holes, gravel, or other debris), road conditions (such as road construction causing lane adjustments, detours, and blocked paths), and traffic conditions (vehicles may obscure view of lane markers and signage, or saturate available wireless networks) may impair vehicle sensors, such as LIDAR, radar, or other sensors.

Driver assistance features may be enabled by low-latency, high capacity, high bandwidth throughput, and high coverage wireless networks, like 5G networks. Some driver assistance features require extensive data processing, as well as frequent communication between a backend server and one or more vehicles. Gaps in wireless network coverage and performance may hinder some driver assistance features. For example, a set or level of driver assistance features may require a minimum wireless network connection performance (e.g., speed, bandwidth, or network generation/type). If a vehicle is driving using the set of driver assistance features and the available wireless network performance falls below the minimum, the vehicle may either switchover to a different set of driver assistance features with a lower wireless network performance requirement, or may abort the trip (e.g., by parking the vehicle), at least until the available wireless network performance is restored. These environments and conditions as well as others may cause driver assistance features to be disabled.

Just as one or more of the above conditions may cause driver assistance features to be disabled, driver assistance features may be re-enabled once the conditions cease or are passed. For example, driver assistance features may be enabled when inclement weather clears, when the map is aligned with the vehicle location, when favorable road geometry or road conditions are encountered, when traffic clears, or when wireless network performance improves.

When driver assistance features are disabled, remote control of a vehicle may be provided. In some cases, when it is unfavorable or unfeasible to have a passenger operate the vehicle (such as when there is no passenger able to take over control), or when having a passenger operate the vehicle would disrupt the experience of the vehicle, the vehicle may be controlled remotely. A remote operator may control the vehicle via a wireless connection to the vehicle or a mobile device. To safely and efficiently control the vehicle, remote control may be provided before or at the time that the driver assistance features are disabled or unsupported. To reduce the resources necessary to operate the vehicle, the remote control may end when driver assistance features are supported and may be re-enabled.

A system monitoring the enabled or disabled driver assistance features may use pattern matching and real time data analysis to predict a region or a path segment where the driver assistance features may be enabled or disabled. To determine when driver assistance features are enabled, the system monitors a mobile device engaging a driver assistance feature mode from a non-driver assistance feature mode (e.g., manual driving mode, or ADAS supported half driver assistance features mode). To determine when driver assistance features are disabled, the system monitors a mobile device (including, for example a vehicle and/or control system in communication with the mobile device or vehicle) disengaging the driver assistance feature mode and switching to a non-driver assistance feature mode (e.g., manual driving mode, or ADAS supported half driver assistance features mode).

Additionally or alternatively, the driving conditions of the mobile device (e.g., connected to or part of an autonomous vehicle) may be monitored by continuously receiving and analyzing the sensor data. In this way, the server or the mobile device may detect abnormal vehicle conditions (e.g., camera, Lidar or other hardware issues, tire issues) incapable of supporting the continuous driver assistance features.

Either the vehicle can initiate a disengaging driver assistance features request, or server system can make a decision to initiate a request to take over the driving. Upon receiving such request either way, a remote control server can take actions like assign a remote driver to take over the driving operation until the driving conditions are capable of supporting driver assistance features, when either the vehicle or the server can decide to let the vehicle or mobile device to take over and continue the driver assistance features.

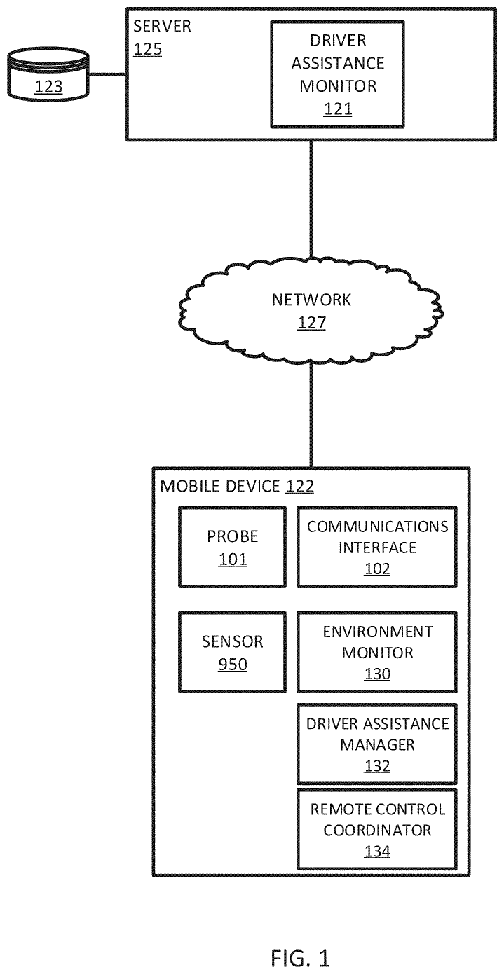

FIG. 1 illustrates a first example of a system for autonomous driving including a mobile device 122, a server 125, and a network 127. Additional, different, or fewer components may be included in the system. The following embodiments may be entirely or substantially performed at the server 125, or the following embodiments may be entirely or substantially performed at the mobile device 122. For example, the driver assistance monitor may be implemented entirely or substantially by the server 125. In another example, the driver assistance monitor may be entirely or substantially implemented by the mobile device 122. In some cases, some aspects are performed at the mobile device 122 and other aspects are performed at the server 125.

The mobile device 122 may include a probe 101, a communications interface 102, an environment monitor 130, a driver assistance manager 132, and a remote control coordinator 134. Though the environment monitor 130, the driver assistance manager 132, and the remote control coordinator 134 are shown as components of the mobile device 122, in some cases, the environment monitor 130, the driver assistance manager 132, and the remote control coordinator 134 and/or others may be components of the server 125 or the driver assistance monitor 121. In some other cases, the environment monitor 130, the driver assistance manager 132, and the remote control coordinator 134 and/or others may be components shared by, enabled by, or performed by, or distributed between the server 125 and the mobile device 122.

The probe 101 may include position circuitry such as one or more processors or circuits for generating probe data. The probe data points are based on sequences of sensor measurements of the probe devices collected in the geographic region. The probe data may be generated by receiving GNSS signals and comparing the GNSS signals to a clock to determine the absolute or relative position of the mobile device 122. The probe data may be generated by receiving radio signals or wireless signals (e.g., cellular signals, the family of protocols known as WIFI or IEEE 802.11, the family of protocols known as Bluetooth, or another protocol) and comparing the signals to a pre-stored pattern of signals (e.g., radio map). The mobile device 122 may act as the probe 101 for determining the position or the mobile device 122 and the probe 101 may be separate devices.

The probe data may include a geographic location such as a longitude value and a latitude value. In addition, the probe data may include a height or altitude. The probe data may be collected over time and include timestamps. In some examples, the probe data is collected at a predetermined time interval (e.g., every second, every 100 milliseconds, or another interval). In this case, there are additional fields like speed and heading based on the movement (i.e., the probe reports location information when the probe 101 moves a threshold distance). The predetermined time interval for generating the probe data may be specified by an application or by the user. The interval for providing the probe data from the mobile device 122 to the server 125 may be the same or different than the interval for collecting the probe data. The interval may be specified by an application or by the user. In some other cases, the probe data is collected dynamically or at different rates. For example, the rate at which the probe data is received may vary based on a trajectory or dynamic behavior of a vehicle or mobile device 122 (e.g., whether the mobile device 122 is travelling at one speed or accelerating/decelerating), a complexity of a path travelled by the mobile device 122 currently or in the future (e.g., whether the mobile device 122 is approaching an intersection, offramp, roundabout), or traffic conditions (e.g., accumulation or dissipation of traffic congestion).

A communications interface 102 may establish, manage, and/or facilitate a wireless connection between the mobile device 122 and the network 127. The communications interface 102 may connect to a network 127 using the 5G standard. In some cases, the communications interface 102 may be able to connect with other standards (e.g., 4G, 3G, 2G) when 5G networks are unavailable. Additionally or alternatively, the communications interface 102 may generate and/or output measures of the performance of the network 127. For example, the communications interface 102 may measure a current or historical speed (download/upload), bandwidth (download/upload), latency, or other performance data of the connection to the network 127. The communications interface 102 may send data from the probe 101 and/or data from the sensor 950 (e.g., sensor data 205) to the server 125 or the driver assistance monitor 121.

Communication between the mobile device 122 and the server 125 through the network 127 may use a variety of types of wireless networks. For example, the network 127 may be a cellular network. The cellular technologies may be analog advanced mobile phone system (AMPS), the global system for mobile communication (GSM), third generation partnership project (3GPP), code division multiple access (CDMA), personal handy-phone system (PHS), and 4G or long-term evolution (LTE) standards, 5G, DSRC (dedicated short-range communication), or another protocol.

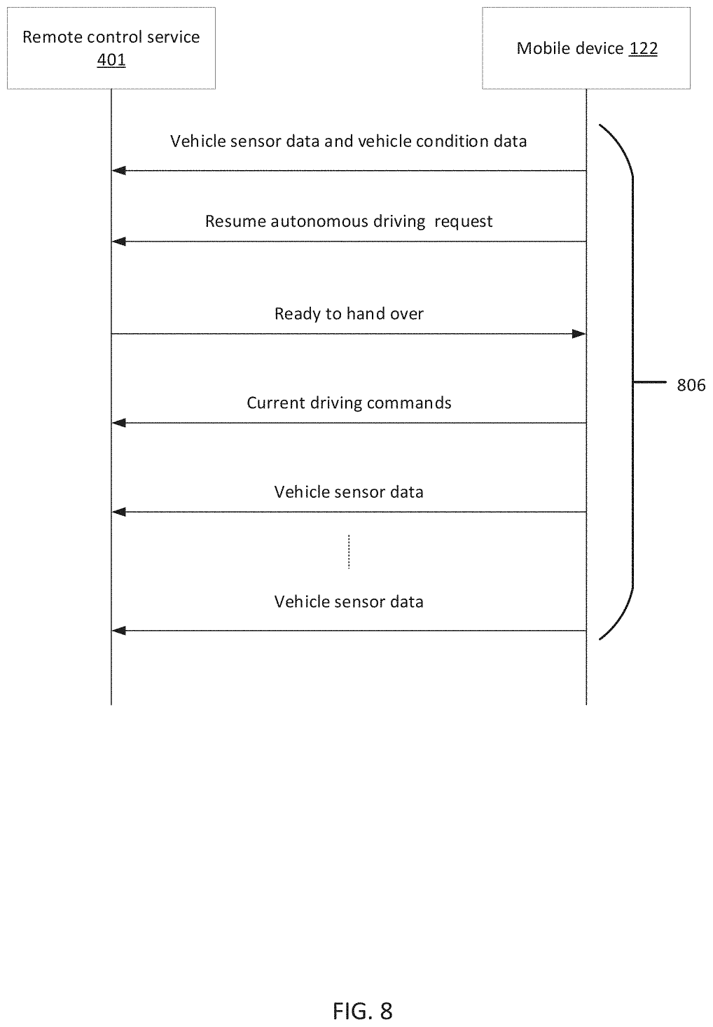

A sensor array 950 may measure one or more elements of the environment of the mobile device 122. The sensor array 950 may produce sensor data 205. The sensor array 950 may be part of or in communication with the mobile device 122. In some cases, the sensor array 950 may include one or more sensors. For example, one sensor of the sensor array 950 may be part of the mobile device, and another sensor of the array 950 may be part of a vehicle 124, such as the vehicle 124 of FIG. 8. The sensor array 950 may include multiple sensors. Example sensors include an optical distance system such as LIDAR 956, an image capture system 955 such as a camera, a sound distance system such as sound navigation and ranging (SONAR), a radio distancing system such as radio detection and ranging (RADAR), a vibration sensor, or another sensor. The camera may be a visible spectrum camera, an infrared camera, an ultraviolet camera, or another camera. In some cases, the sensor array may include an engine sensor 951. The engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

The environment monitor 130 may be configured to receive probe data and/or sensor data. Additionally or alternatively, the environment monitor 130 may be configured to receive traffic data, incident data, map data, weather data. The data received by the environment manager may describe or define the conditions of the mobile device 122, including internal conditions (e.g., vibration data, engine data, steering input data) and external conditions (e.g., LIDAR data, wireless network performance data, weather data). The data may describe the conditions of the mobile device 122 at a current location of the mobile device 122, or at a previous or future position of the mobile device 122. In some cases, the environment manager may receive a path that the mobile device 122 is traversing. The data received by the environment manager may be linked to one or path segments or locations on the path. For example, the weather or traffic information may be linked to a further location or path segment of the path not yet traversed by the mobile device 122. In another example, map data is linked to a location or path segment on the path. In this way, gaps or absences along the path may be identified so that remote control of the mobile device 122 may be employed during those gaps or absences.

The driver assistance manager 132 may be configured to compare the conditions defined by the probe data and the sensor data to a requirement to enable a driver assistance feature for the mobile device 122. In this way, the driver assistance manager may determine whether or not the driver assistance features are supported based on the data. In some cases, the conditions may be compared to the requirement to determine whether driver assistance features are supported at a location on a path of the mobile device 122. The location may be the present location of the mobile device 122 of the path, or a previous or future location on the path. In this way, the driver assistance manager 132 may predict when and/or where the conditions will support or fail to support the driver assistance features along the path. In some cases, based on the determination that the conditions fail to support the driver assistance features, the driver assistance manager may disable the driver assistance features. In some other cases, based on the determination that the conditions support the driver assistance features, the driver assistance manager may enable the driver assistance features.

The environment monitor 130 may continually or periodically receive or collect the data defining new conditions of the mobile device 122. In this way, the new data may be used by the driver assistance manager 132 may update a previous determination that the conditions support or do not support the driver assistance features. This allows for disabled driver assistance features to be re-enabled when the new conditions support the driver assistance features.

The remote control coordinator 134 may be configured to output a navigation message requesting remote control of the vehicle when the conditions fail to meet the requirement to enable the driver assistance feature (e.g., as determined by the driver assistance manager 132). Additionally or alternatively, the remote control coordinator 134 may be configured to output a navigation message requesting cessation of remote control of the vehicle when the conditions meet the requirement to enable the driver assistance feature. In some cases, the navigation command may request the start or end of driver assistance features based on a location on the path or a time that the mobile device 122 is traversing the path. For example, based on the determination from the driver assistance manager 132 that the conditions support or will fail to support the driver assistance features at a location on the path or a time when the mobile device 122 is traversing the path, the remote control coordinator 134 may schedule a time or a place for the remote control of the vehicle based on the location on the path.

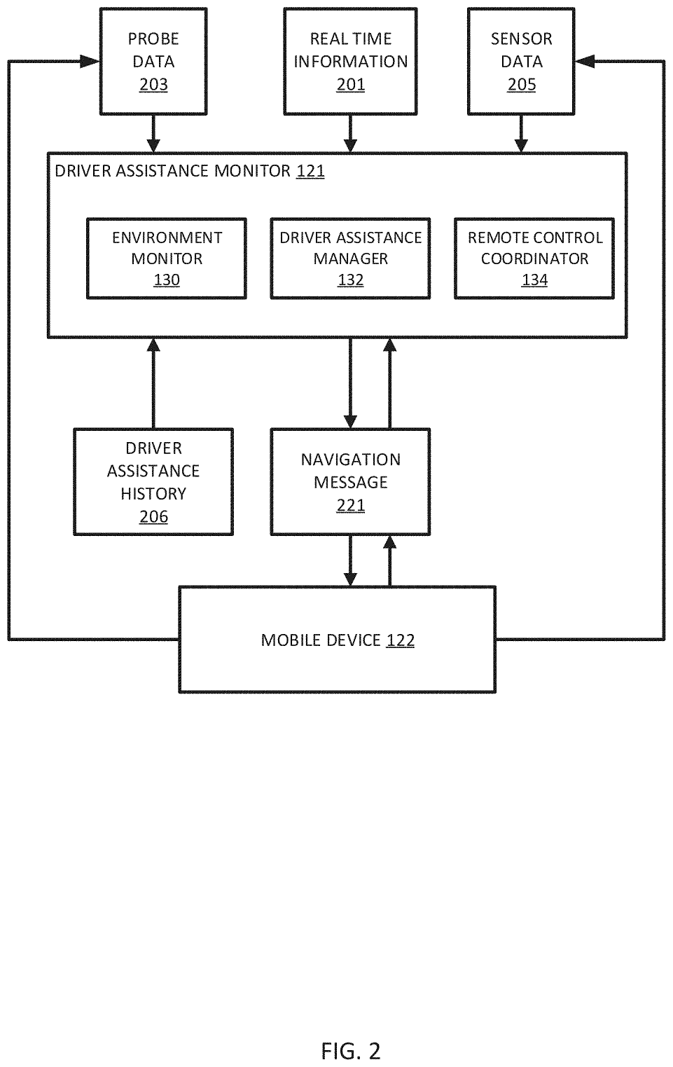

FIG. 2 illustrates an example of the driver assistance 121 monitor of FIG. 1. While FIG. 1 illustrates the driver assistance monitor 121 at the server 125, the mobile device 122 may additionally or alternatively implement the driver assistance monitor 121. In some cases, elements of the driver assistance monitor 121 may be shared or divided between the server 125 and the mobile device 122. Additional, different, or fewer components may be included. The driver assistance monitor may include an environment monitor 130, a driver assistance manager 132, and a remote control coordinator.

The driver assistance monitor 121 receives data from one or more sources. The environment monitor 130 may be configured to receive the data defining the conditions of the mobile device. The data sources may include traffic information 201, probe data 203, sensor data 205, and driver assistance history data 206, but additional data sources are discussed in other embodiments. In some cases, the probe data 203 may include data from the sensor 950 of the mobile device. In some other cases, data from the sensor 950 may be received separately from the probe data 203.

The traffic information 201 may include data regarding traffic flow, traffic speed, traffic density, traffic incidents (closed lanes, stopped vehicles, accidents, etc.) or other information for a path segment. The traffic information 201 may be dynamically updated. For example, new or updated traffic information 201 may be received on a regular or changing interval. The traffic information 201 may be received from a traffic service provider.

The probe data 203 may be generated by the probe 101. The probe data 203 may include any type of position information and may be determined by the mobile device 122 and stored by the mobile device 122. In some cases, the probe data 203 may be collected or received in response to collection of the sensor data 205. For example, when the probe data 203 is measured or collected, network performance data associated with the probe data 203 may also be collected or measured. In other cases, the probe data 203 may be collected or received separately or independently from the network performance data. For example, the probe data 203 may be collected periodically or at a first interval, while the sensor data 205 is collected at a different interval or at other times. The probe data 203 may include geographic coordinates, a heading, and/or a speed.

In some cases, the probe data 203 may include a current set of driver assistance features enabled, or the occurrence a switchover from one set of features to another.

The probe data 203 and the sensor data 205 may be combined. For example, sensor data 205 of the sensor array 950 may be annotated with probe data 203. The mobile device 122 may be configured to generate combined data using the probe data 203 collected by the probe 101 and the sensor data 205 generated by the sensory array 950.

The probe data 203 may include network performance data, such as information about the network 127 that the mobile device 122 is connected to. The sensor data 205 may include data about (or measurements of) speed, bandwidth, or network generation/type. The network performance data may be generated by the communications interface 102.

The sensor data 205 may be generated by the sensor array 950 of the mobile device 122. The sensor data 205 may include data generated by one or more sensors of the sensor array 950. For example, the sensor data 205 may include data from an optical distance system such as LIDAR 956, an image capture system 955 such as a camera, a sound distance system such as sound navigation and ranging (SONAR), a radio distancing system such as radio detection and ranging (RADAR), a vibration sensor, or another sensor.

The traffic information 201, probe data 203 and/or the sensor data 205 may be collected at a particular frequency. Examples for the particular frequency may be 1 sample per second (1 Hz) or greater (more frequent). The sampling frequency for either the probe data 203 and the sensor data 205 may be selected based on the sampling frequency available for the other of the probe data 203 and the sensor data 205. The driver assistance monitor 121 is configured to down-sample (e.g., omit samples or average samples) in order to equalize the sampling frequency of the probe data 203 with the sampling frequency of the sensor data 205, or vice versa. In some cases, the frequency that the probe data 203 and the sensor data 205 are collected may vary. For example, the rate at which the probe data 203 is received may vary based on a trajectory or dynamic behavior of the mobile device 122 (e.g., whether the mobile device 122 is travelling at one speed or accelerating or decelerating), a complexity of a path travelled by the mobile device 122 currently or in the future (e.g., whether the mobile device 122 is approaching an intersection, offramp, roundabout), or traffic conditions (e.g., accumulation or dissipation of traffic congestion).

In some cases, the probe data 203 and sensor data 205 may be associated with one or more path segments. Based on a location in the probe data 203 or sensor data 205, the driver assistance monitor 121 may match the location to a path segment. The path segment may be included in traffic information 201 received from a geographic database, such as geographic database 123. The traffic information 201 may include information for the path segment matched to the probe data 203.

The driver assistance history data 206 may include one or more patterns or situations in which driver assistance features were supported or unsupported. The patterns may include conditions defined or described by the data, such as the probe data 203, the traffic information 201, and the sensor data 205. For example, the pattern may include a location (e.g., driver assistance features are unsupported in this parking lot or garage), a piece of the sensor data (e.g., the LIDAR indicates that other vehicles are very close to the mobile device 122).

Based on the received data defining the conditions of the mobile device 122 and the driver assistance history data 206 having patterns or requirements for enabling driver assistance features, the driver assistance manager 132 may compare the conditions to the patterns and requirements to determine whether the driver assistance features are enabled by the conditions.

A navigation message 221 may be generated and output by the driver assistance monitor 121. For example, the remote control coordinator 134 may be configured to output the navigation message 221. The mobile device 122 may be configured to receive the navigation message 221. The navigation message 221 provides for remote control of the mobile device 122. For example, the navigation message 221 may connect or disconnect the mobile device 122 and a remote control service. In some cases, the navigation message 221 may provide for the connection or disconnection of the remote control at the time that the navigation message 221 is received. In some other cases, the navigation message 221 may provide for the connection or disconnection of the remote control at a time in the future or at a location, such as a location on a path traversed by the mobile device 122. Multiple navigation messages 221 may be sent by the driver assistance monitor 121. For example, when conditions of the mobile device 122 fail to support autonomous driving, a navigation message 221 may be output by the driver assistance monitor 121 providing for remote control of the mobile device. When further conditions of the mobile device 122 support driver assistance features (e.g., based on new data received by the driver assistance monitor 121), another navigation message 221 may be output by the driver assistance monitor 121 disengaging the remote control of the mobile device 122. In some cases, the remote control coordinator 134 of the driver assistance monitor 121 or the mobile device 122 may be configured to output the navigation message 221.

In some cases, the remote control coordinator 134 (e.g., located on the mobile device 122, as shown in FIG. 1) may output a navigation message 221 from the mobile device 122. The navigation message may request remote control of the vehicle, or request cessation of remote control of the mobile device 122. The driver assistance monitor 121 may communicate with a remote control service to provide or disable remote control of the mobile device 122.

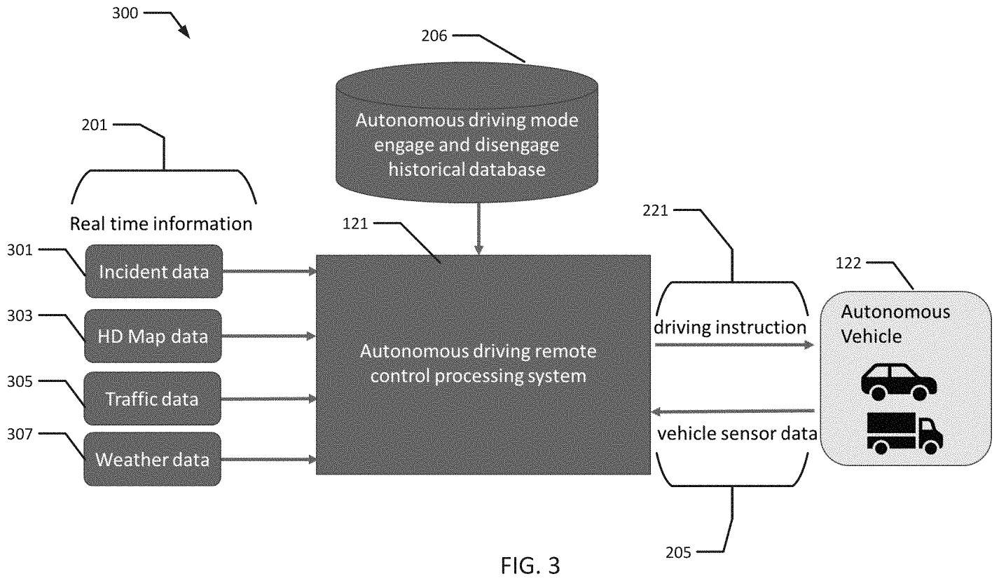

FIG. 3 illustrates a system 300 including another example of the driver assistance monitor 121 of FIG. 1. The driver assistance monitor 121 is configured to send driving instructions (e.g., using a navigation message 221) to an autonomous vehicle (e.g., a mobile device 122) based on input data 201, 205, 206. The system 300 is configured to continuously receive traffic information 201 (e.g., in real time) which affect autonomous driving operations and to receive driver assistance history data 206 (e.g., including offline autonomous driving mode analytic data) indicating a region or path segments where driver assistance features engage and disengage. Additionally or alternatively, the system 300 may monitor the autonomous vehicle conditions by receiving the vehicle sensor data 205 (e.g., camera, lidar, tire pressure, engine speed) over a network 127.

Disengagement of the driver assistance features may happen or be caused by one or more external conditions (e.g., missing HD map contents, road accidents, inclement weather) or internal conditions (e.g., malfunctions of hardware or software of the mobile device 122).

Once the system 300 (e.g., the driver assistance monitor 121) or the mobile device 122 detects or predicts that such conditions are occurring or may occur, either the system 300 or the mobile device 122 may initiate an autonomous driving request (e.g., a navigation message 221) and further request remote control of the mobile device 122. When the request is granted (e.g., by a remote control service), remote control of the mobile device 122 may be engaged, either by a human or non-human operator. The remote control service may send driving commends (e.g., with navigation messages 221) such as steering input, throttle position, or brake input to the mobile device 122 over a network 127 while monitoring the conditions of the mobile device 122. When conditions of the mobile device 122 fulfill the requirement to enable or support the autonomous driving features, the system 300, mobile device 122, and/or remote control service may agree for the remote control to cease and for the mobile device 122 to resume local operation.

The traffic information 201 received by the system 300 may include incident data 301, map data 303, traffic data 305, and/or weather data 307. The incident data 301 may include events such as strikes, sports events, music festivals, civil emergencies. The map data 303 may include lane level features, in some cases down to a centimeter level resolution, and 3D space maneuvers. The traffic data 305 may include traffic density, speed, and other information for a region or path segment. The weather data 307 may include historical, present, and forecasted weather conditions for a region or path segment, including direction and speed of weather conditions.

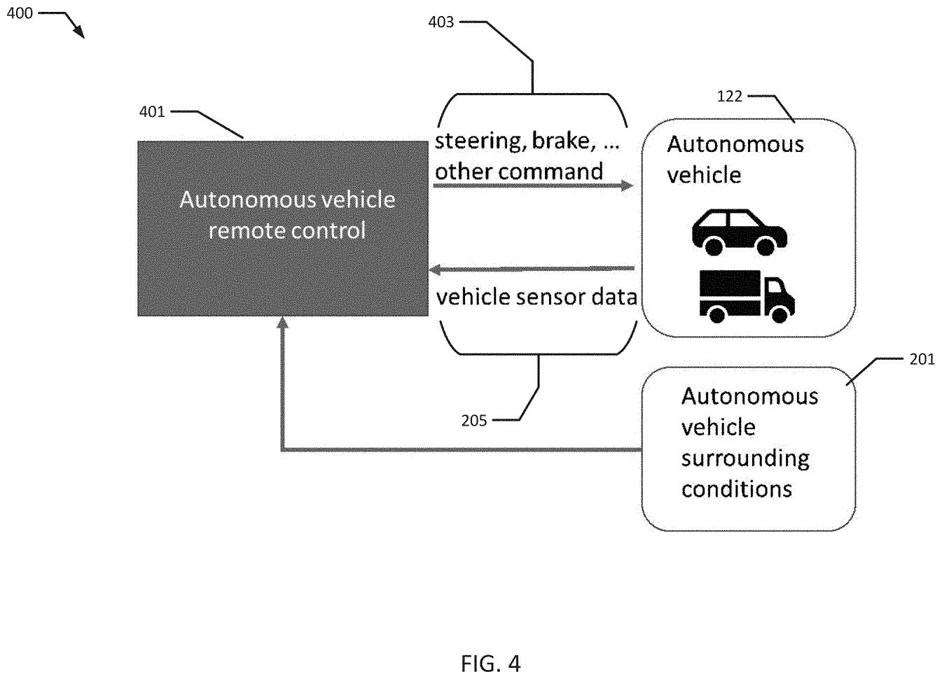

FIG. 4 illustrates a system 400 for remote control of a vehicle. First, a remote control service 401 receives the environment of the mobile device from sensors on the mobile device 122 or from a vehicle in communication with or integrated with the mobile device 122, such as camera data or LIDAR data. In some cases, sensor data 205 may be received from other mobile devices 122 in proximity to the mobile device 122 based on the proximity of the other mobile devices 122 to the mobile device 122 or based on other data, such as from cameras in communication with or in proximity to the mobile device 122.

Then, in response to a request for remote control of the mobile device 122 generated by either the mobile device or the driver assistance monitor 121, the remote control service will engage remote control of the mobile device 122 with a human or non-human operator. Remote control of the mobile device 122 may be provided by sending driving commands 403 to the mobile device 122, such as steering input, throttle position, brake input, and/or an air/fuel mixture.

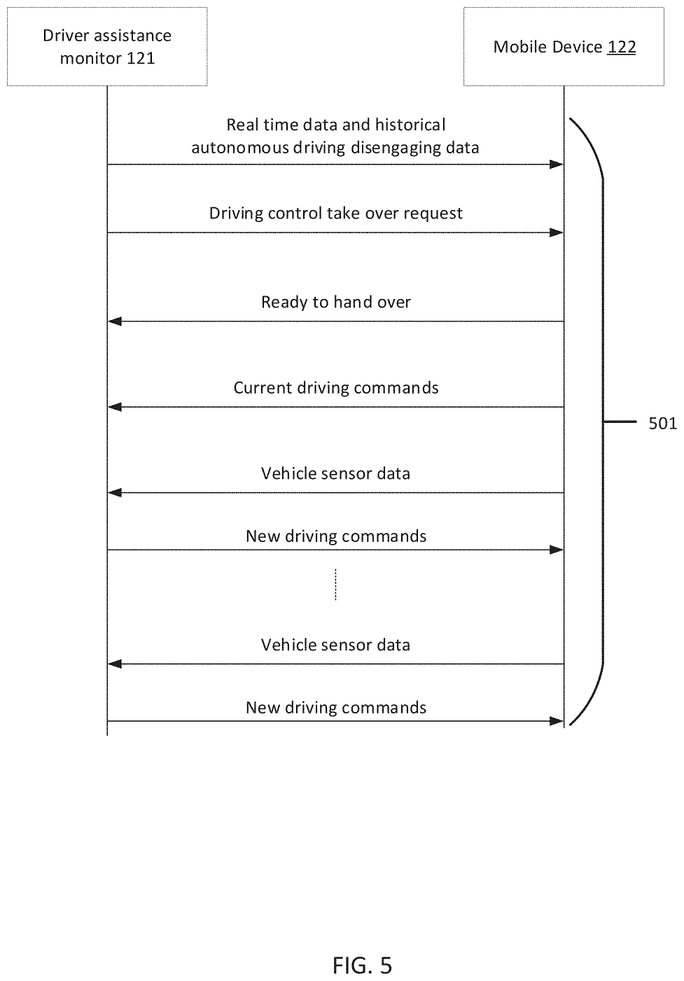

FIGS. 5-8 illustrate message exchanges between a remote control service 401 and a mobile device 122. The messages 501, 601, 701, 806 are exchanged to start and cease remote operation of the mobile device 122.

FIG. 5 illustrates the process of changing from operation with driver assistance features to remote control of the mobile device 122. In this case, the process is initiated by a driver assistance monitor 121. As described before, when the driver assistance monitor 121 recognizes that driver assistance features are unsupported and remote control of the mobile device 122 is appropriate, the driver assistance monitor 121 may send a request for remote control of the mobile device 122 to the mobile device 122. In some cases, the driver assistance monitor 121 may send the real time data along with historical driving mode engage and disengaging data to the mobile device 122. The mobile device 122 may align the sensor data with the received real time data and historical data to determine when disengagement of the driver assistance features may occur and begin the process of engaging remote control.

The mobile device 122 may prepare to engage remote control. One or more events may be resolved prior to starting remote control. For example, an obstacle on the path, unexpected behavior of other vehicles, or other events may be resolved or navigated by the mobile device 122 before the mobile device 122 is ready to engage remote control. Additionally or alternatively, the mobile device 122 may prepare for remote control by preparing sensor data to be sent to the remote control service and to receive driving control commands from the remote control service or the driver assistance monitor 121. In some cases, control systems part of or in communication with the mobile device 122 may be configured to send the sensor data and receive the driving commands. These control systems may be coordinated or synchronized prior to engaging remote control. Once the mobile device 122 is ready to hand over to the remote control service 401, the remote control service 401 can start driving the autonomous vehicle remotely.

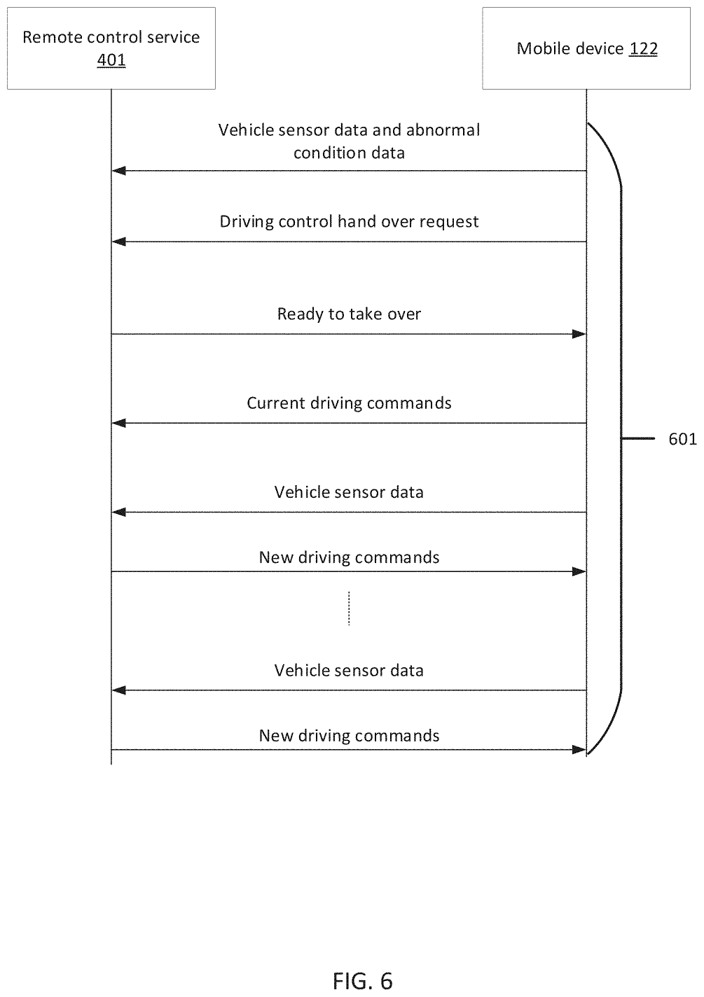

FIG. 6 illustrates the process of changing from operation with driver assistance features to remote control of the mobile device 122. In this case, the process is initiated by the mobile device 122. As described above, once the mobile device 122 detects that the vehicle conditions (e.g., tire pressure, insufficient map content, wireless network performance) fail to support the driver assistance features, the mobile device 122 will generate a request for remote control of the mobile device 122 by the remote control service 401 and also send the data defining the conditions of the mobile device 122 (e.g., probe data 203, sensor data 205). Once the remote control service 401 is ready to initiate remote control of the mobile device 122, the remote control service 401 will send a message indicating the readiness to the mobile device 122, after which the remote control service 401 may start operating the mobile device 122 remotely.

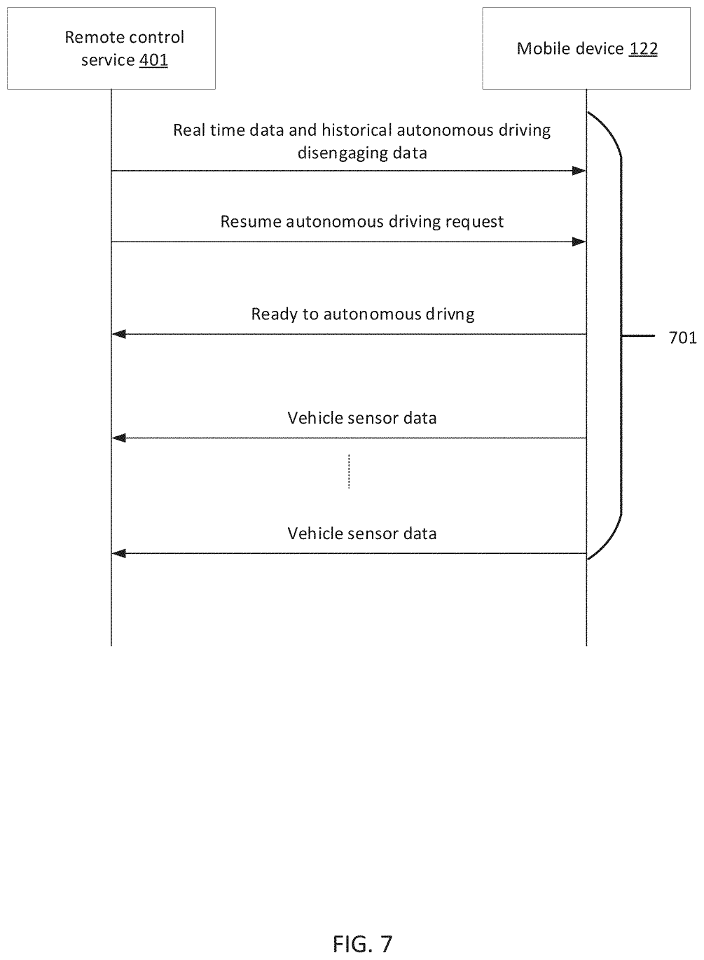

FIG. 7 illustrates the process for resuming control of the mobile device 122 according to the supported driver assistance features. The process is initiated by the driver assistance monitor 121 determining that conditions of the mobile device 122 support the driver assistance features. Once the driver assistance monitor 121 determines that the driver assistance features are supported, the remote control service 401 may initiate control of the mobile device 122 according to the driver assistance features by sending the traffic information 201 along with driver assistance history data 206 regarding engagement and disengagement of the driver assistance features. Once the mobile device 122 is ready, the mobile device 122 may resume operation according to the driver assistance features.

FIG. 8 illustrates the process for resuming control of the mobile device 122 according to the supported driver assistance features. The process is initiated by the mobile device 122 determining that conditions of the mobile device 122 support the driver assistance features. Once the mobile device 122 determines that the conditions (e.g., tire pressure, insufficient map content, wireless network performance) are capable of supporting the driver assistance features, the mobile device 122 may generate a request to resume control by the driver assistance features and send the request to disable remote control to the remote control service 401, along with the data defining the conditions (e.g., probe data 203, sensor data 205). Once the remote control service 401 is ready disengage remote control of the mobile device 122, the remote control service may send a message to the mobile device 122 indicating readiness. Then, the mobile device 122 may resume operation according to the driver assistance features.

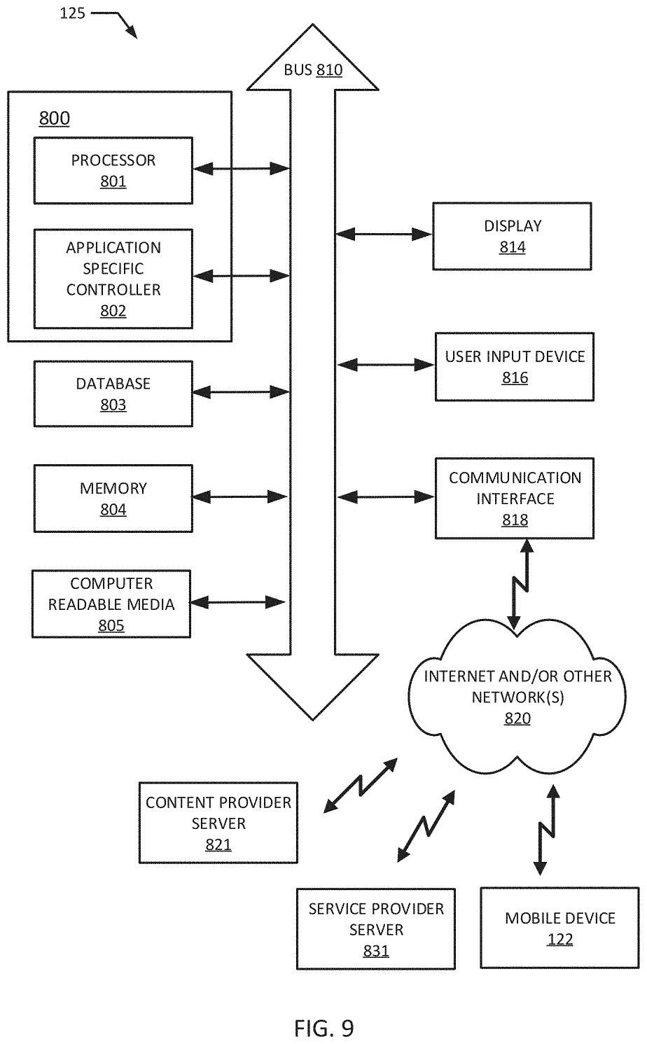

FIG. 9 illustrates an example of the server 125 for the system of FIG. 1. The server 125 may include a bus 810 that facilitates communication between a controller (e.g., the driver assistance monitor 121) that may be implemented by a processor 801 and/or an application specific controller 802, which may be referred to individually or collectively as controller 800, and one or more other components including a database 803, a memory 804, a computer readable medium 805, a display 814, a user input device 816, and a communication interface 818 connected to the internet and/or other networks 820. The contents of database 803 are described with respect to geographic database 123. The database 803 (e.g., a server-side database) may be a master database that provides data in portions to the database 903 of the mobile device 122. Additional, different, or fewer components may be included.

The memory 804 and/or the computer readable medium 805 may include a set of instructions that can be executed to cause the server 125 to perform any one or more of the methods or computer-based functions disclosed herein. In a networked deployment, the system of FIG. 6 may alternatively operate or as a client user computer in a client-server user network environment, or as a peer computer system in a peer-to-peer (or distributed) network environment. It can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. While a single computer system is illustrated, the term “system” shall also be taken to include any collection of systems or sub-systems that individually or jointly execute a set, or multiple sets, of instructions to perform one or more computer functions.

The server 125 may be in communication through the network 820 with a content provider server 821 and/or a service provider server 831. The server 125 may provide the point cloud to the content provider server 821 and/or the service provider server 831. The content provider may include device manufacturers that provide location-based services associated with different locations POIs that users may access.

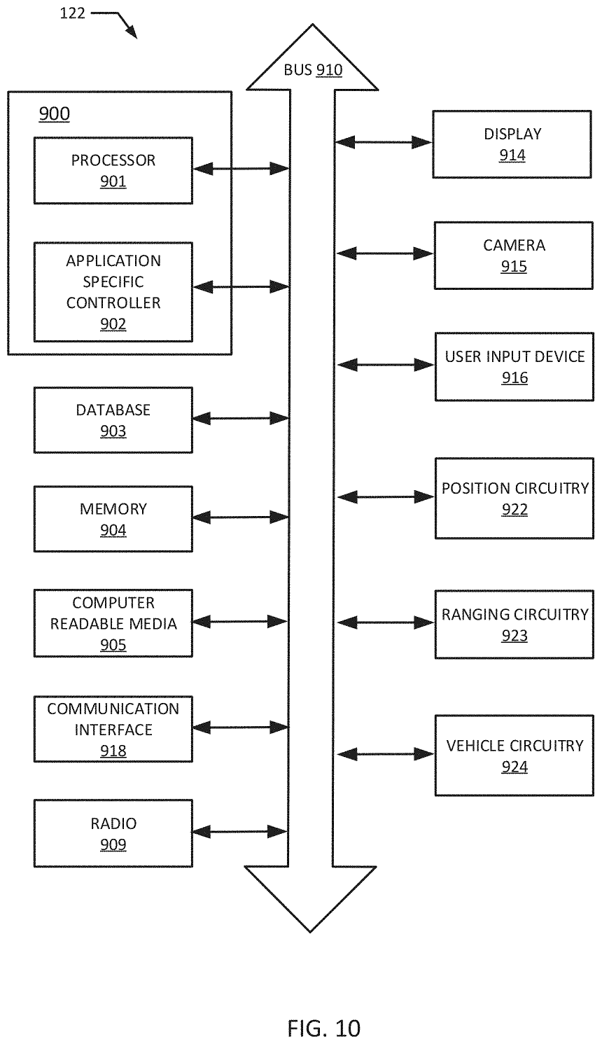

FIG. 10 illustrates an example of the mobile device 122 of FIG. 1. The mobile device 122 may include a bus 910 that facilitates communication between a controller (e.g., the driver assistance monitor 121) that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a camera 915, a user input device 916, positioning circuitry 922, ranging circuitry 923, and vehicle circuitry 924. The contents of the database 903 are described with respect to geographic database 123. The database 903 may be a user database that receives data in portions from the database 903 of the mobile device 122. The communication interface 918 connected to the internet and/or other networks (e.g., network 820 shown in FIG. 6). The vehicle circuitry 924 may include any of the circuitry and/or devices described with respect to FIG. 7. Additional, different, or fewer components may be included.

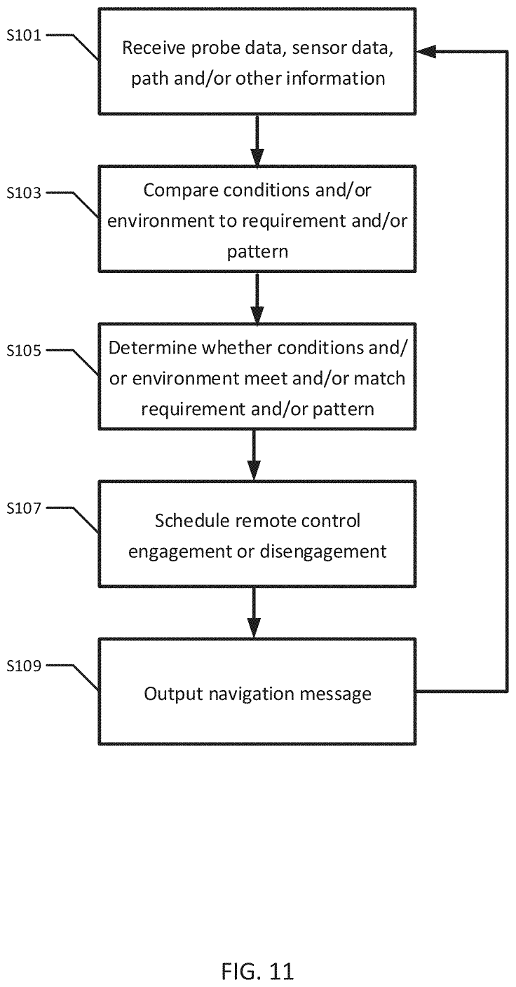

FIG. 11 illustrates an example flow chart. The acts may be performed by the server 125 of FIG. 9 and/or the example mobile device 122 of FIG. 10. For example, the mobile device 122 and/or the server 125 (e.g., the driver assistance monitor 121) may determine that conditions of the mobile device 122 (defined by probe, sensor, real-time, and/or historical data) support or fail to support driver assistance features and may generate a request to cease or begin remote operation of the mobile device 122 accordingly. Additional, different, or fewer acts may be included. For example, acts S103 or 107 may be omitted. The acts may be performed in a different order than shown. For example, act S109 may proceed from act S105.

In act S101, data is received. Traffic information 201 (including in some cases, incident data 301, map data 303, traffic data 305, and/or weather data 307), probe data 203, sensor data 205, and/or a vehicle path. In some cases, the environment monitor 130 may be configured to receive the data. The sensor data 205 may include data from a camera, LIDAR, an engine sensor, a vibration sensor, or another sensor. The received data defines the conditions of the mobile device, both external (e.g., in the environment around and/or affecting the mobile device 122 as measured by sensors of the mobile device 122) and internal (a state of the mobile device, such as hardware and software). Additionally or alternatively, the data may be received from vehicles, sensors, or sources in the proximity to the mobile device. In one example, data may be received from vehicles or other mobile devices 122 in proximity to the mobile device 122, or in proximity to a path travelled by the mobile device.

The received information 201, 205, 205 may be associated with a region or path segment of the vehicle path. For example, the map data may be associated with a region proximal to the path or with one or path segments of the path. In this way, the map data may indicate regions or path segments where map data is absent or missing. Such absences of map data (alone or in combination with other received data) may define the conditions that fail to support driver assistance features.

In act S103, the conditions defined by the received data are compared to a requirement or pattern supporting a driver assistance feature. A driver assistance manager 132 may be configured to compare the received data. The requirement or pattern may specify certain minimum, maximum, or threshold conditions that support the autonomous driving feature. By comparing the conditions to the requirements or historical patterns, the environment of the mobile device 122 or of the path traversed by the mobile device may be matched to the conditions that enable or disable the driver assistance features.

The pattern or requirement may be based on historical data collected about when mobile devices enable or disable driver assistance features. For example, the historical data may include the conditions during present when a vehicle or mobile device 122 enabled or disabled a driver assistance feature (sometimes known as a “switchover”). Based on the collected conditions, patterns may be generated based on common conditions present when the driver assistance features were enabled or disabled. Such conditions identifiable from the historical data include presence or absence of map data, tire pressure, engine vibration, traffic congestion levels, wireless network performance levels, and others. Accordingly, the pattern specifies conditions that, when present at or around the mobile device 122, are likely to support or fail to support the driver assistance features. In some cases, an OEM, such as a manufacturer of the mobile device 122 or a service provider in communication with the mobile device 122, may publish specified requirements necessary to enable driver assistance features of the mobile device 122.

In act S105, it is determined whether or not the conditions support a driver assistance feature. The A driver assistance manager 132 may be configured to determine whether the conditions support or fail to support the driver assistance features. The conditions, defined by the received information, may be determined to support or fail to support the driver assistance features based on whether the conditions fulfill or fail to fulfill patterns or requirements for the driver assistance features, such as the historical patterns or requirements compared to the conditions as in act S103.

In some cases, the conditions may describe a current environment of the mobile device 122, or the environment of a region or location on the path traversed by the mobile device 122. The determination that the conditions support or fail to support the driver assistance features may be made for the current environment of the vehicle, or with regard to the region or location. In this way, a disengagement or engagement of the driver assistance features may be predicted at a time or a place relative to the path. For example, there may be a parking garage further on the path traveled by the mobile device 122 where the conditions are missing map data, low wireless network performance, and/or missing GPS probe location data. The conditions of the parking garage may be determined to fail to support one or more driver support features. Accordingly, it may be predicted that at the location or region around the parking garage that the driver assistance features of the mobile device 122 may be disengaged. As a result, remote control of the vehicle may be planned to be provided in the parking garage where the driver assistance features will be disengaged. Similarly, further conditions around or outside of the parking garage may support the previously disengaged driver assistance features. Based on the further conditions, the remote control of the mobile device 122 may be planned to disengage when and/or where the mobile device 122 exits the parking garage and the driver assistance features may be re-enabled.

In act S107, a time or a place for the engagement or disengagement of the remote control of the mobile device 122 may be scheduled. The remote control coordinator 134 may be configured to schedule the remote control of the mobile device 122. In some cases, the remote control of the vehicle may be scheduled at a time or a place on a vehicle path. In the example above, remote control of the mobile device 122 is provided while the mobile device 122 is present in a parking garage. The place may be the location of the parking garage on the path of the mobile device 122. The time may be the estimated or predicted time that the mobile device will enter or exit the parking garage. The time or place may be determined based on the received data (such as vehicle speed indicated in probe data 203 or sensor data 205). The remote control may be scheduled by providing the time or place to a remote control service 401.

In act S109, a navigation message is output. The remote control coordinator 134 may be configured to output the navigation message. In some cases, such as when the mobile device 122 determines that the conditions do not support driver assistance features, the navigation message may be output by the mobile device 122. In some cases, the driver assistance monitor 121 in communication with the mobile device 122 may output the navigation message. The message may be sent to the mobile device 122 (e.g., when output by the driver assistance monitor 121), the driver assistance monitor 121 (e.g., when generated by the mobile device 122), and/or the remote control service 401. As shown in FIGS. 5-8, multiple messages may be passed between the mobile device 122, the driver assistance monitor 121, and/or the remote control service 401 to engage and disengage the remote control of the vehicle.

Acts S101, S103, S105, S107, and/or S109 may be repeated. For instance, further data may be received in act S101 so that further conditions of the mobile device 122 may be evaluated. The further conditions may be compared to requirements or patterns for enabling or disabling the driver assistance features, as in act S103. The further conditions may be determined, as in act S105, to meet or fail to meet the requirement or pattern to enable or disable the driver assistance features. Based on the determining, in some cases, an engagement or disengagement of the driver assistance features may be scheduled, as in act S107. Further, based on the determining, a navigation message providing for starting or ceasing remote control of the mobile device 122 may be output, as in act S109.

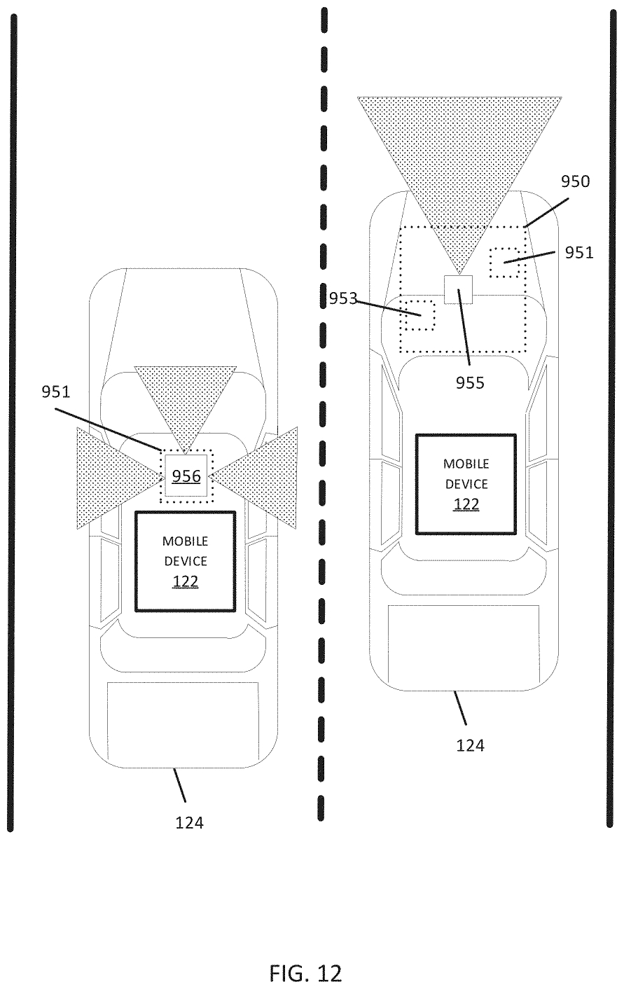

FIG. 12 illustrates an example of the vehicle 124 associated with the system of FIG. 1 for providing location-based services or application using the point clouds described herein as well as collecting data for such services or applications and/or the generation of the point clouds described herein. The vehicles 124 may include a variety of devices that collect position data as well as other related sensor data for the surroundings of the vehicle 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively or additionally, the one or more detectors or sensors may include an accelerometer built or embedded into or within the interior of the vehicle 124. The vehicle 124 may include one or more distance data detection device or sensor, such as a LIDAR device. The distance data detection sensor may generate point cloud data. The distance data detection sensor may include a laser range finder that rotates a mirror directing a laser to the surroundings or vicinity of the collection vehicle on a roadway or another collection device on any type of pathway. The distance data detection device may generate the trajectory data. Other types of pathways may be substituted for the roadway in any embodiment described herein.

A connected vehicle includes a communication device and an environment sensor array 950 for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server. The network may be the Internet or connected to the internet.

The sensor array 950 may include one or more sensors configured to detect surroundings of the vehicle 124. The sensor array 950 may include multiple sensors. Example sensors include an optical distance system such as LIDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the vehicle 124, which may include assisted driving vehicles such as autonomous vehicles, highly automated driving (HAD), and advanced driver assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to routes including path segments) received from geographic database 123 and the server 125 and driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to routes including path segments received from geographic database 123 and the server 125 and driving commands or navigation commands.

A highly automated driving (HAD) vehicle may refer to a vehicle that does not completely replace the human operator. Instead, in a highly automated driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to routes including path segments received from geographic database 123 and the server 125 and driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the routes including path segments received from geographic database 123 and the server 125 and driving commands or navigation commands.

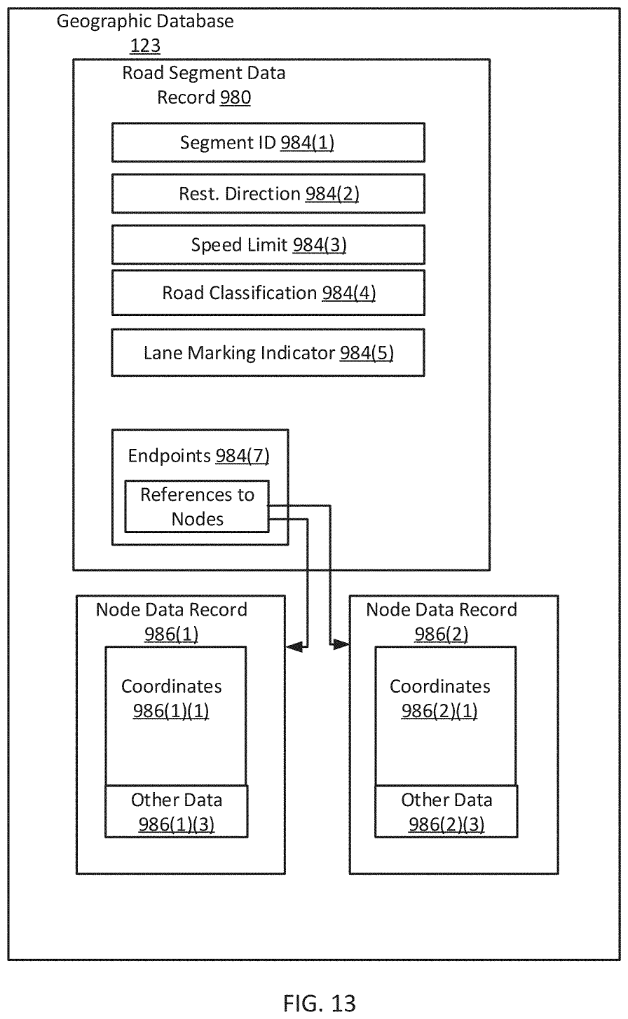

FIG. 13 illustrates components of a road segment data record 980 contained in the geographic database 123 according to one embodiment. The road segment data record 980 may include a segment ID 984(1) by which the data record can be identified in the geographic database 123. Each road segment data record 980 may have associated information (such as “attributes”, “fields”, etc.) that describes features of the represented road segment. The road segment data record 980 may include data 984(2) that indicate the restrictions, if any, on the direction of vehicular travel permitted on the represented road segment. The road segment data record 980 may include data 984(3) that indicate a speed limit or speed category (i.e., the maximum permitted vehicular speed of travel) on the represented road segment. The road segment data record 304 may also include classification data 984(4) indicating whether the represented road segment is part of a controlled access road (such as an expressway), a ramp to a controlled access road, a bridge, a tunnel, a toll road, a ferry, and so on. The road segment data record may include location fingerprint data, for example a set of sensor data for a particular location.

The geographic database 123 may include road segment data records 980 (or data entities) that describe current, historical, or future patterns of driver assistance switchovers and/or the causes of the switchovers for the road segment (such as conditions causing driver assistance features to be enabled/disabled). Additionally or alternatively, the data records 980 may include requirements for enabling driver assistance features for the road segment. Additional schema may be used to describe road objects. The attribute data may be stored in relation to geographic coordinates (e.g., the latitude and longitude) of the end points of the represented road segment. In one embodiment, the endpoints 984(7) include references to the node data records 986 that represent the nodes corresponding to the end points of the represented road segment.

The road segment data record 980 may also include or be associated with other data that refer to various other attributes of the represented road segment. The various attributes associated with a road segment may be included in a single road segment record or may be included in more than one type of record which cross-references to each other. For example, the road segment data record may include data identifying what turn restrictions exist at each of the nodes which correspond to intersections at the ends of the road portion represented by the road segment, the name, or names by which the represented road segment is identified, the street address ranges along the represented road segment, and so on.

The road segment data record 908 may also include endpoints 984(7) that reference one or more node data records 986(1) and 986(2) that may be contained in the geographic database 123. Each of the node data records 986 may have associated information (such as “attributes”, “fields”, etc.) that allows identification of the road segment(s) that connect to it and/or its geographic position (e.g., its latitude and longitude coordinates). The node data records 986(1) and 986(2) include the latitude and longitude coordinates 986(1)(1) and 986(2)(1) for their node, the node data records 986(1) and 986(2) may also include other data 986(1)(3) and 986(2)(3) that refer to various other attributes of the nodes. In one example, the node data records 986(1) and 986(2) include the latitude and longitude coordinates 986(1)(1) and 986(2)(1) and the other data 986(1)(3) and 986(2)(3) reference other data associated with the node.

The controller 900 may communicate with a vehicle ECU which operates one or more driving mechanisms (e.g., accelerator, brakes, steering device). Alternatively, the mobile device 122 may be the vehicle ECU, which operates the one or more driving mechanisms directly.

The controller 800 or 900 may include a routing module including an application specific module or processor that calculates routing between an origin and destination. The routing module is an example means for generating a route in response to the anonymized data to the destination. The routing command may be a driving instruction (e.g., turn left, go straight), which may be presented to a driver or passenger, or sent to an assisted driving system. The display 914 is an example means for displaying the routing command. The mobile device 122 may generate a routing instruction based on the anonymized data.

The routing instructions may be provided by display 914. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

The mobile device 122 may plan a route through a road system or modify a current route through a road system in response to the request for additional observations of the road object. For example, when the mobile device 122 determines that there are two or more alternatives for the optimum route and one of the routes passes the initial observation point, the mobile device 122 selects the alternative that passes the initial observation point. The mobile devices 122 may compare the optimal route to the closest route that passes the initial observation point. In response, the mobile device 122 may modify the optimal route to pass the initial observation point.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. In some cases, the mobile device 122 may be a drone or other piloted or non-piloted aircraft. Non-limiting embodiments of navigation devices may also include relational database service devices, mobile phone devices, car navigation devices, and navigation devices used for air or water travel.

The geographic database 123 may include map data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the map data. The map data may include structured cartographic data or pedestrian routes. The map data may include map features that describe the attributes of the roads and intersections. The map features may include geometric features, restrictions for traveling the roads or intersections, roadway features, or other characteristics of the map that affects how vehicles 124 or mobile device 122 for through a geographic area. The geometric features may include curvature, slope, or other features. The curvature of a road segment describes a radius of a circle that in part would have the same path as the road segment. The slope of a road segment describes the difference between the starting elevation and ending elevation of the road segment. The slope of the road segment may be described as the rise over the run or as an angle. The geographic database 123 may also include other attributes of or about the roads such as, for example, geographic coordinates, street names, address ranges, speed limits, turn restrictions at intersections, and/or other navigation related attributes (e.g., one or more of the road segments is part of a highway or toll way, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The databases may also contain one or more node data record(s) which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, wireless network performance data, autonomous driving switch mode records, and maneuver data.

The geographic database 123 may contain at least one road segment data record 304 (also referred to as “entity” or “entry”) for each road segment in a particular geographic region. The geographic database 123 may also include a node database record (or “entity” or “entry”) for each node in a particular geographic region. The terms “nodes” and “segments” represent only one terminology for describing these physical geographic features, and other terminology for describing these features is intended to be encompassed within the scope of these concepts. The geographic database 123 may also include location fingerprint data for specific locations in a particular geographic region.

The radio 909 may be configured to radio frequency communication (e.g., generate, transit, and receive radio signals) for any of the wireless networks described herein including cellular networks, the family of protocols known as WIFI or IEEE 802.11, the family of protocols known as Bluetooth, or another protocol.

The memory 804 and/or memory 904 may be a volatile memory or a non-volatile memory. The memory 804 and/or memory 904 may include one or more of a read-only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 818 and/or communication interface 918 may include any operable connection. An operable connection may be one in which signals, physical communications, and/or logical communications may be sent and/or received. An operable connection may include a physical interface, an electrical interface, and/or a data interface. The communication interface 818 and/or communication interface 918 provides for wireless and/or wired communications in any now known or later developed format.

The user input device 916 may be one or more buttons, keypad, keyboard, mouse, stylus pen, trackball, rocker switch, touch pad, voice recognition circuit, or other device or component for inputting data to the mobile device 122. The user input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the user input device 916 may involve a device having velocity detecting abilities.

The ranging circuitry 923 may include a LIDAR system, a RADAR system, a structured light camera system, SONAR, or any device configured to detect the range or distance to objects from the mobile device 122.

The positioning circuitry 922 may include suitable sensing devices that measure the traveling distance, speed, direction, and so on, of the mobile device 122. The positioning system may also include a receiver and correlation chip to obtain a GPS signal. Alternatively or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The positioning circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network devices.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
receiving, by a processor, probe data and sensor data from a mobile device;
comparing, by the processor, conditions defined by the probe data and the sensor data to a requirement to enable a driver assistance feature for the mobile device;
determining, by the processor, that the conditions fail to meet the requirement to enable the driver assistance feature based on the probe data and the sensor data; and
outputting, by the processor, a navigation message to the mobile device providing for remote control of the mobile device when the conditions fail to meet the requirement to enable the driver assistance feature.

2. The method of claim 1, further comprising:
receiving, by the processor, traffic data, incident data, map data, weather data, or a combination thereof,
wherein the conditions are defined by the traffic data, incident data, map data, weather data, or the combination thereof.

3. The method of claim 1, wherein the sensor data includes data from a camera, light detection and ranging (LIDAR), an engine sensor, or a vibration sensor.

4. The method of claim 1, further comprising:
receiving, by the processor, a path for the mobile device,
wherein the conditions are determined to fail to meet the requirement to support the driver assistance feature at a location on the path, and
wherein the navigation message provides for remote control of the mobile device based on the location on the path.

5. The method of claim 4, further comprising:
scheduling, by the processor, a time or a place for the remote control of the mobile device based on the location on the path,
wherein the navigation message provides for remote control at the time or at the place.

6. The method of claim 4, further comprising:
receiving, by the processor, traffic data, incident data, map data, weather data, or a combination thereof, the map data being absent at the location on the path,
wherein the conditions are defined by the traffic data, incident data, map data, weather data, or the combination thereof, and
wherein the conditions are determined to fail to meet the requirement to support the driver assistance feature based on the map data being absent at the location on the path.

7. The method of claim 6, further comprising:
receiving, by the processor, further probe data and further sensor data generated by the mobile device;
comparing, by the processor, further conditions defined by the further probe data and the further sensor data to the requirement to enable the driver assistance feature for the mobile device;
determining, by the processor, that the further conditions fulfill the requirement to enable the driver assistance feature at a further location on the path based on the further probe data and the further sensor data; and
outputting, by the processor, a further navigation message to the mobile device disabling remote control of the mobile device based on the further location on the path.

8. The method of claim 1, further comprising:
receiving, by the processor, further probe data and further sensor data generated by the mobile device;
comparing, by the processor, further conditions defined by the further probe data and the further sensor data to the requirement to enable the driver assistance feature for the mobile device;
determining, by the processor, that the further conditions fulfill the requirement to enable the driver assistance feature based on the further probe data and the further sensor data; and
outputting, by the processor, a further navigation message to the mobile device disabling remote control of the mobile device when the further conditions fulfill the requirement to enable the driver assistance feature.

9. A vehicle system comprising:
an environment monitor configured to receive probe data and sensor data for a mobile device;
a driver assistance manager configured to compare conditions defined by the probe data and the sensor data to a requirement to enable a driver assistance feature for the vehicle and to determine that the driver assistance feature is unsupported by the conditions based on the probe data and the sensor data; and
a remote control coordinator configured to output a navigation message requesting remote control of the vehicle when the conditions fail to meet the requirement to enable the driver assistance feature.

10. The vehicle system of claim 9, wherein the environment monitor is configured to receive traffic data, incident data, map data, weather data, or a combination thereof, and
wherein the conditions are defined by the traffic data, incident data, map data, weather data, or the combination thereof.

11. The vehicle system of claim 9, wherein the sensor data includes data from a camera, LIDAR, an engine sensor, or a vibration sensor.

12. The vehicle system of claim 9, wherein the environment monitor is configured to receive a path for the vehicle,
wherein the conditions are determined to fail to meet the requirement to support the driver assistance feature at a location on the path, and
wherein the navigation message requests remote control of the vehicle based on the location on the path.

13. The vehicle system of claim 12, wherein the remote control coordinator is configured to schedule a time or a place for the remote control of the vehicle based on the location on the path,
wherein the navigation message requests remote control at the time or at the place.

14. The vehicle system of claim 12, wherein the environment monitor is configured to receive traffic data, incident data, map data, weather data, or a combination thereof, the map data being absent at the location on the path,
wherein the conditions are defined by the traffic data, incident data, map data, weather data, or the combination thereof, and
wherein the conditions are determined to fail to meet the requirement to support the driver assistance feature based on the map data being absent at the location on the path

15. The vehicle system of claim 14, wherein the environment monitor is configured to receive further probe data and further sensor data,
wherein the driver assistance manager is configured to compare further conditions defined by the further probe data and the further sensor data to the requirement to enable the driver assistance feature for the vehicle and determine that the further conditions fulfill the requirement to enable the driver assistance feature at a further location on the path based on the further probe data and the further sensor data, and
wherein the remote control coordinator is configured to output a further navigation message to the mobile device disabling remote control of the vehicle based on the further location on the path.

16. The vehicle system of claim 9, wherein the environment monitor is configured to receive further probe data and further sensor data,
wherein the driver assistance manager is configured to compare further conditions defined by the further probe data and the further sensor data to the requirement to enable the driver assistance feature for the vehicle and determine that the further conditions fulfill the requirement to enable the driver assistance feature based on the further probe data and the further sensor data, and
wherein the remote control coordinator is configured to output a further navigation message to the mobile device enabling remote control of the vehicle when the further conditions fulfill the requirement to enable the driver assistance feature.

17. A non-transitory computer-readable medium including instructions that when executed are operable to:
receive probe data and sensor data describing an environment of a vehicle;
compare the environment described by the probe data and the sensor data to a pattern for disabling a driver assistance feature of the vehicle;
determine that the environment matches the pattern for disabling a driver assistance feature of the vehicle; and
output a navigation message to the vehicle providing for remote control of the vehicle when the environment matches the pattern for disabling the driver assistance feature.

18. The non-transitory computer-readable medium of claim 17 operable to:
receive a path for the vehicle, wherein the environment is determined to match the pattern for disabling the driver assistance feature of the vehicle at a location of the path; and
schedule a time or a place for the remote control of the vehicle based on the location of the path,
wherein the navigation message provides for remote control of the vehicle at the time or at the place based on the location of the path.

19. The non-transitory computer-readable medium of claim 17 operable to:
receive further probe data and further sensor data describing a further environment of the vehicle;
compare the further environment described by the further probe data and the further sensor data to the pattern for disabling the driver assistance feature of the vehicle;
determine that the further environment fails to match the pattern for disabling the driver assistance feature based on the further probe data and the further sensor data; and
output a further navigation message to the vehicle disabling remote control of the vehicle when the further environment fails to match the pattern for disabling the driver assistance feature.
